(19) United States
(12) Patent Application Publication
(10) Pub. No.: US 2024/0291025 A1
(43) Pub. Date: Aug. 29, 2024

(54) METHOD OF RECOVERING SULFIDE SOLID ELECTROLYTE

(71) Applicant: TOYOTA JIDOSHA KABUSHIKI KAISHA, Toyota-shi (JP)

(72) Inventors: Hikaru SUGANUMA, Susono-shi (JP); Keiichi Minami, Tagata-gun (JP)

(73) Assignee: TOYOTA JIDOSHA KABUSHIKI KAISHA, Toyota-shi (JP)

(21) Appl. No.: 18/433,625

(22) Filed: Feb. 6, 2024

(30) Foreign Application Priority Data
Feb. 28, 2023 (JP) 2023-029322

(51) Int. Cl. H01M 10/0562

(52) U.S. Cl. CPC H01M 10/0562; H01M 2300/0068

(57) ABSTRACT

In a method of recovering a sulfide solid electrolyte, the sulfide solid electrolyte includes lithium, phosphorus, sulfur, and an M element, the M element includes at least one element selected from a group consisting of germanium, tin, and silicon, and the sulfide solid electrolyte is heated at a temperature of 100° C. or more under an environment with a dew point temperature of −70° C. or less.

### CROSS REFERENCE TO RELATED APPLICATIONS

This nonprovisional application is based on Japanese Patent Application No. 2023-029322 filed on Feb. 28, 2023 with the Japan Patent Office, the entire contents of which are hereby incorporated by reference.

### BACKGROUND

### Field

The present disclosure relates to a method of recovering a sulfide solid electrolyte.

### Description of the Background Art

WO2011/118801 discloses a sulfide solid electrolyte comprising lithium, germanium, phosphorus and sulfur.

### SUMMARY

Since the sulfide solid electrolyte described in WO2011/118801 has excellent ion conductivity, it is considered possible to provide a high-performance all-solid-state battery. However, when exposed to atmospheric air, the sulfide solid electrolyte described in WO2011/118801 reacts with moisture to generate hydrogen sulfide and the composition of the sulfide solid electrolyte is changed, with the result that the ion conductivity is decreased. Further, since the changed composition of the sulfide solid electrolyte is not reverted, with the result that it is difficult to recover the ion conductivity.

It is an object of the present disclosure to provide a method by which ion conductivity of a sulfide solid electrolyte can be recovered.

[1] A method of recovering a sulfide solid electrolyte, wherein
the sulfide solid electrolyte includes lithium, phosphorus, sulfur and an M element,
the M element includes at least one element selected from a group consisting of germanium, tin, and silicon, and
the sulfide solid electrolyte is heated at a temperature of 100° C. or more under an environment with a dew point temperature of −70° C. or less.

The sulfide solid electrolyte including lithium, phosphorus, sulfur and the at least one selected from the group consisting of germanium, tin, and silicon has excellent ion conductivity. The sulfide solid electrolyte is expected to be recovered by heating the sulfide solid electrolyte at a temperature of 100° C. or more under an environment with a dew point temperature of −70° C. or less. This is presumably due to the following reason: the environment with a dew point temperature of −70° C. or less includes substantially no moisture and the moisture in the sulfide solid electrolyte is vaporized and evaporated by performing heating at a temperature of 100° C. or more.

[2] The method of recovering a sulfide solid electrolyte according to [1], wherein
the sulfide solid electrolyte is represented by the following formula (1):

Li₄₋ₓM₁₋ₓPₓS₄ (1), and
in the formula (1), x satisfies a relationship of 0.55≤x≤0.76.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a bar graph showing recovery rates of ion conductivity in sulfide solid electrolytes of Examples 1 and 2 and Comparative Examples 1 and 2.

### DESCRIPTION OF THE PREFERRED EMBODIMENTS

Embodiments of the present disclosure (hereinafter, simply referred to as “the present embodiment”) and examples of the present disclosure (hereinafter, simply referred to as “the present example”) are described below. However, the present embodiment and the present example do not limit the technical scope of the present disclosure.

Solid electrolyte may be abbreviated as “SE” herein.

### <Recovery Method of Sulfide Solid Electrolyte>

### <<Sulfide Solid Electrolyte>>

The sulfide SE in the present embodiment contains lithium (Li), phosphorus (P), sulfur (S), and M element. The M element includes at least one element selected from the group consisting of germanium (Ge), tin (Sn), and silicon (Si). Such sulfide SE may have, for example, a composition represented by the following formula (1).

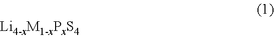

In the formula (1), x may satisfy, for example, a relationship of 0.55≤x≤0.76. When x is within the above range, it is considered that a decrease in ion conductivity is suppressed because moisture as an impurity is small. X may be, for example, 0.6 or more, 0.65 or more, or 0.7 or more. X may be, for example, 0.75 or less, 0.7 or less, 0.65 or less, or 0.6 or less. In the following formula (1), the sulfide SE when M is Ge, the sulfide SE when M is Sn, and the sulfide SE when M is Si may be referred to as “LGPS-based sulfide SE”, “LSnPS-based sulfide SE” and “LSiPS-based sulfide SE”, respectively.

### <<Recovery Method>>

The sulfide SE in the present embodiment is recovered by heating at a temperature of 100° C. or more in an environment having a dew point temperature of −70° C. or less.

Here, the “dew point temperature” is a temperature at which condensation starts when air containing water vapor is cooled, and can be measured by a dew point thermometer or the like. The dew point temperature in the present embodiment may be −70° C. or less, −80° C. or less, −90° C. or less, or −100° C. or less. It is considered that moisture is hardly contained in an environment in which the dew point temperature is −70° C. or less. The lower limit of the dew point temperature in the present embodiment is not particularly limited as long as it is −70° C. or less. Such an environment can be constructed, for example, in a glove box in which the dew point temperature can be controlled.

In the present embodiment, heating is performed at a temperature of 100° C. or more. Thus, it is considered that moisture in the sulfide SE can be vaporized and evaporated. The heating temperature is preferably high, and may be 150° C. or more, or 200° C. or more. However, if the heating temperature is too high, since the composition of the sulfide SE may change, the heating temperature may be, for example, 600° C. or less, 450° C. or less, or 300° C. or less. The heating means is not particularly limited and, for example, a conventionally known heating means such as a hot plate can be used.

The heating time can be appropriately determined depending on the heating temperature and the degree of ion conductivity to be recovered. The heating time may be, for example, between minutes and hours.

By using such a recovery method, it is considered that in the all-solid-state battery including the sulfide SE described above, for example, there are advantages such as reduction of the photothermal cost in the factory, recycling from damages such as accidents, prolonged use year and month by maintenance, and maintenance of high output by mounting a heat regeneration system.

### EXAMPLES

### Example 1

Lithium sulfide (Li₂S), diphosphorus pentasulfide (P₂S₅) and germanium sulfide (GeS₂) were prepared as starting materials. The raw materials were mixed at 500 rpm for 10 hours using a ball mill. The mixed powder was fired in a glove box having a dew point temperature of −70° C. in an argon (Ar) atmosphere at 600° C. for 10 hours to prepare LGPS-based sulfide SE of Example 1. The sulfide solid electrolyte in this example is represented by the following formula (2):

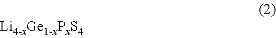

In the above formula (2), x satisfies the relationship of 0.55≤x≤0.76.

### Example 2

As starting materials, Li₂S, P₂S₅ and tin disulfide (SnS₂) were prepared. The raw materials were mixed at 500 rpm for 10 hours using a ball mill. The mixed powder was fired in a glove box having a dew point temperature of −70° C. in an Ar atmosphere at 600° C. for 10 hours to prepare LSnPS-based sulfide SE of Example 2. The sulfide solid electrolyte in this example is represented by the following formula (3):

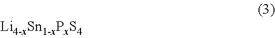

In the above formula (3), x satisfies the relationship of 0.55≤x≤0.76.

### Comparative Example 1

As starting materials, Li₂S, P₂S₅ and lithium chloride (LiCl) were prepared. The raw materials were mixed at 500 rpm for 10 hours using a ball mill. The mixed powder was fired in a glove box having a dew point temperature of −70° C. in an Ar atmosphere at 500° C. for 10 hours to prepare a sulfide SE of Comparative Example 1.

### Comparative Example 2

As starting materials, Li₂S, P₂S₅, lithium bromide (LiBr) and lithium iodide (LiI) were prepared. The raw materials were weighed to have a composition of 20LiI-10LiBr-70Li₃PS₄ and mixed for 10 hours at a rotation speed of 500 rpm using a ball mill. The mixed powder was fired in a glove box having a dew point temperature of −70° C. in an Ar atmosphere at 200° C. for 5 hours to prepare a sulfide SE of Comparative Example 2.

### Comparative Examples 3 to 4

In Comparative Example 3, the same LGPS-based sulfide SE as in Example 1 was used, and in Comparative Example 4, the same LSnPS-based sulfide SE as in Example 2 was used.

### <Evaluation>

### (Exposure)

10 mg of sulfide SE of Examples 1 and 2 and Comparative Examples 1 and 2 was exposed in a glove box at a dew point temperature of −30° C. for 5 hours in an Ar atmosphere. After exposure, it was returned again into a glove box at a dew point temperature of −70° C. and heated at 165° C. for 1 hour.

Further, 10 mg of sulfide SE of Comparative Examples 1 to 4 was exposed in a glove box at a dew point temperature of −30° C. for 5 hours in an Ar atmosphere. After exposure, the mixture was returned to a glove box at a dew point temperature of −70° C. and heated at 100° C. for 1 hour.

### (Measurement of Ion Conductivity)

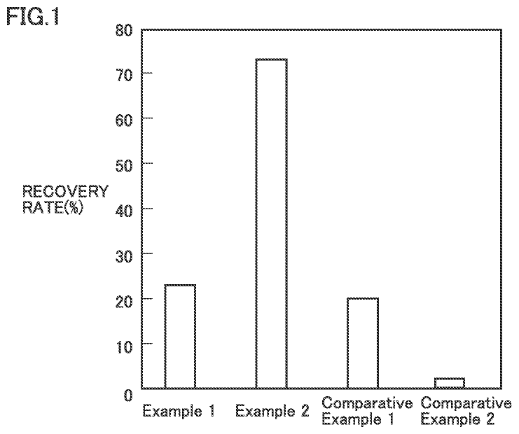

The Li ion conductivity of the sulfides SE of Examples 1 and 2 and Comparative Examples 1 to 4 was measured using an AC impedance method. The measurements were performed (1) after preparation of each sulfide SE, (2) after exposure at a dew point temperature of −30° C., and (3) after heating at a dew point temperature of −70° C. The results are shown in Table 1. As described above, (3) heating at the dew point temperature of −70° C. was performed at 165° C. in Examples 1 and 2, at 100° C. and 165° C. in Comparative Examples 1 and 2, and at 100° C. in Comparative Examples 3 and 4. The rate of ion conductivity measured in (3) (hereinafter referred to as “recovery rate”) with respect to the ion conductivity measured in (1) was calculated. The results are shown in Table 1 and FIG. 1.

### (Measurement of Hydrogen Sulfide Generation Amount)

The amount (ppm) of H₂S generated when the sulfide SE of each of Examples 1 and 2 and Comparative Examples 1 and 2 was exposed in a glove box at a dew point temperature of −30° C. for 5 hours in an Ar atmosphere was measured. The measurement was carried out using a hydrogen sulfide measuring instrument manufactured by Shinohara Electric Co., Ltd.

### (Measurement of Moisture Amount)

The amount (mass %) of vaporized moisture when the sulfide SE of each of Examples 1 and 2 and Comparative Examples 1 and 2 was exposed in a glove box having a dew point temperature of −30° C. for 5 hours in an Ar atmosphere was measured. The measurement was performed by heating to 300° C. using a thermogravimetric mass spectrometer (TG-MS). A thermogravimetric differential thermal analyzer (TG-DTA) manufactured by Rigaku was used as the apparatus, and an MS device manufactured by Shimadzu Corporation was used as the apparatus. The results are shown in Table 1.

### (X-Ray Diffractometry)

The sulfides SE of Examples 1 and 2 and Comparative Examples 1 and 2 were subjected to X-ray diffraction (XRD) measurement using CuKα rays. The measurement was performed (1) immediately after preparation of each sulfide SE, (2) after exposure at a dew point temperature of −30° C., and (3) after heating at a dew point temperature of −70° C.

TABLE 1

| | Ion Conductivity (mS/cm) | | | | Recovery Rate (%) | | |
|---|---|---|---|---|---|---|---|
| | | | After | After | After | After | Moisture |
| | After | After | Heating | Heating | Heating | Heating | Amount |
| | Preparation | Exposure | at 100° C. | at 165° C. | at 100° C. | at 165° C. | (Mass %) |
| Example 1 | 4.82 | 0.11 | — | 1.10 | — | 22.8 | 0.51 |
| Example 2 | 3.30 | 0.38 | — | 2.40 | — | 72.7 | 0.68 |
| Comparative | 3.78 | 0.86 | 0.28 | 0.75 | 7.4 | 19.8 | 0.62 |
| Example 1 | | | | | | | |
| Comparative | 5.20 | 0.31 | 0.28 | 0.04 | 5.4 | 0.8 | 3.81 |
| Example 2 | | | | | | | |
| Comparative | 4.82 | 0.11 | 0.11 | — | 2.3 | — | 0.51 |
| Example 3 | | | | | | | |
| Comparative | 3.30 | 0.38 | 0.29 | — | 8.8 | — | 0.68 |
| Example 4 | | | | | | | |

### Results

### Example

When exposed to exposure in a glove box at a dew point temperature of −30° C. for 5 hours, the ion conductivity decreased, but the ion conductivity was recovered by returning again to the glove box at a dew point temperature of −70° C. and heating at 165° C. for 1 hour.

Upon exposure in a glove box at a dew point temperature of −30° C. for 5 hours, little H₂S occurred and was less than 5 ppm after 5 hours. In addition, when exposure was performed in a glove box having a dew point temperature of −30° C. for 5 hours, the amount of vaporized moisture was less than 1.0 mass %, which was a small amount.

As a result of the XRD measurement, no difference was observed in the spectra (1) to (3). That is, it is considered that the composition of each sulfide SE does not change. From the measurement result of the moisture amount, it is considered that, even when exposure was performed in a glove box having a dew point temperature of −30° C. for 5 hours, moisture hardly adheres to the surface of the sulfide SE, and the moisture slightly adhered was evaporated by heating at 165° C. without reacting with the bulk. Further, in Example 2, it is considered that the reaction between the bulk and the moisture was further suppressed by the strong binding force between Sn and S, and the ion conductivity was further recovered.

### Comparative Example

When exposed in a glove box at a dew point temperature of −30° C. for 5 hours, the ion conductivity decreased. Further, ion conductivity did not recover even when the mixture was returned to a glove box at a dew point temperature of −70° C. and heated at 100° C. and/or 165° C. for 1 hour.

When exposure was carried out in a glove box having a dew point temperature of −30° C. for 5 hours, the amount of H₂S generated in Comparative Example 1 reached 100 ppm as the detection limit at about 15 minutes after the start of exposure. Further, the amount of H₂S generated in Comparative Example 2 reached 20 ppm after about 1.5 hours, but gradually decreased thereafter.

When exposure was performed in a glove box having a dew point temperature of −30° C. for 5 hours, the amount of vaporized moisture in Comparative Example 1 was less than 1.0% by mass and was small. On the other hand, the vaporized moisture amount of Comparative Example 2 was 3.81% by mass, and a large amount of moisture was adhered.

As a result of the XRD measurement, in Comparative Example 1, a change was observed in the spectrum of (3) as compared with the spectra of (1) and (2).

According to the measurement result of the amount of H₂S, when exposure was performed in a glove box having a dew point temperature of −30° C. for 5 hours, a large amount of H₂S was generated, and S in the sulfide SE disappeared and the composition was changed. As a result, it is considered that LiBr and LiI were generated on the surface of the sulfide SE by returning to the glove box at the dew point temperature of −70° C. and heating at 165° C. for 1 hour. It is considered that the ion conductivity did not recover due to the composition change of the sulfide SE.

In Comparative Example 2, a change was observed in the spectra of (2) and (3) as compared with the spectra of (1). From the measurement result of the moisture amount, it was found that moisture was accumulated on the surface of the sulfide SE when exposure was performed in a glove box having a dew point temperature of −30° C. for 5 hours. As a result, it is considered that the stored moisture reacts with the bulk and β-Li₃PS₄ was generated by returning to a glove box having a dew point temperature of −70° C. and heating at 165° C. for 1 hour. It is considered that the ion conductivity did not recover due to the composition change of the sulfide SE.

In Comparative Examples 3 and 4, it is considered that the ion conductivity was not recovered by heating at a low temperature (100° C.) because moisture adhered at the time of exposure at the dew point temperature of −30° C. remained on the surface of the sulfide SE.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of recovering a sulfide solid electrolyte, wherein
the sulfide solid electrolyte includes lithium, phosphorus, sulfur and an M element,
the M element includes at least one element selected from a group consisting of germanium, tin, and silicon, and
the sulfide solid electrolyte is heated at a temperature of 100° C. or more under an environment with a dew point temperature of −70° C. or less.

2. The method of recovering the sulfide solid electrolyte according to claim 1, wherein
the sulfide solid electrolyte is represented by the following formula (1):
Li₄₋ₓM₁₋ₓPₓS₄ (1), and
in the formula (1), x satisfies a relationship of 0.55≤x≤0.76.
